(19) United States
(12) Patent Application Publication
(10) Pub. No.: US 2009/0219439 A1
(43) Pub. Date: Sep. 3, 2009

(54) System and Method of Deinterlacing Interlaced Video Signals to Produce Progressive Video Signals

(76) Inventors: Graham Sellers, Toronto (CA); Ryan Morris, London (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/039,279

(22) Filed: Feb. 28, 2008

(51) Int. Cl. H04N 7/01

(52) U.S. Cl. 348/452; 348/E07.003

(57) ABSTRACT

A method of deinterlacing interlaced even scanline and odd scanline video frames to form a progressive video frame comprises populating even scanlines of an even full-field frame with the scanlines of the interlaced even scanline video frame and populating odd scanlines of an odd full-field frame with the scanlines of the interlaced odd scanline video frame; subjecting each of the even and odd full-field frames to a doubling procedure to populate odd scanlines of the even full-field frame and to populate even scanlines of the odd full-field frame thereby to complete the even and odd full-field frames; processing the complete even and odd full-field frames to determine motion; and selecting pixels of the interlaced even scanline and odd scanline video frames and one of the complete even and odd full-field frames using the determined motion thereby to generate the progressive video frame.

### FIELD OF THE INVENTION

The present invention relates generally to video signal processing and in particular, to a system and method of deinterlacing interlaced video signals to produce progressive video signals.

### BACKGROUND OF THE INVENTION

Transmitting video signals in interlaced form as a stream of video frames is common and is an effective form of compression. Typically only one-half of the information of each source video image is used to form the video frames of the interlaced stream. The information of the source video images that is used to form the interlaced video frames alternates so that successive interlaced video frames include either the even scanlines of the associated source video image or the odd scanlines of the associated source video image. During display of interlaced video signals, provided the switch between video frames comprising even scanlines and video frames comprising odd scanlines is rapid, the displayed video image appears whole to the user.

In many computing applications, deinterlacing interlaced video frames is performed as part of a recompression process. Deinterlacing is the process of converting a stream of interlaced video frames into a stream of progressive video frames whereby each progressive video frame includes both the even and odd scanlines. During deinterlacing, for each video frame, the missing scanlines are generated to complete the progressive video frame. In the case of video frames of static scenes, merging consecutive or successive interlaced video frames to form a complete progressive video frame yields an acceptable result. Unfortunately, if the video frames include objects in motion, merging successive interlaced video frames to form a complete progressive video frame yields unacceptable results.

Turning now to FIGS. 1a and 1b, a video frame 10a comprising even scanlines 12a and a consecutive video frame 10b comprising odd scanlines 12b are shown. In each video frame, a static rectangular object 104 exists. Because the object 14 is static, even though the video frames 10a and 10b are consecutive (i.e. generated at different times), the object 14 appears in the same location in each video frame. As a result, when the video frames 10a and 10b are merged to form a completed progressive video frame 16 as shown in FIG. 1c, the object 14 is complete yielding an acceptable result.

FIGS. 1d and 1e show a video frame 20a comprising even scanlines 22a and a consecutive video frame 20b comprising odd scanlines 22b. Similar to FIGS. 1a to 1c, in each video frame a rectangular object 24 exists. In this case however, the object 24 is in lateral motion over the time in which the video frames 20a and 20b are generated and thus, the object 24 is not in the same location in each video frame. As a result, when the video frames 20a and 20b are merged to form a complete progressive video frame 26 as shown in FIG. 1f, the object 24 is distorted yielding an unacceptable result.

Many techniques to deinterlace interlaced video frames and create progressive video frames without distortion have been considered. For example, U.S. Pat. No. 6,262,773 to Westerman discloses a system for processing an image containing a first line and a second line, where the first and second lines include a plurality of pixels, to generate an interpolated line. The system selects first and second sets of pixels from the lines and generates a first set and second set of filtered values. Edge locations in the first and second sets of the filtered values are identified and the identified edge locations are interpolated to generate an interpolated pixel.

U.S. Pat. No. 6,421,090 to Jiang et al. discloses an apparatus and method for interpolating a pixel during the de-interlacing of a video signal. The video signal includes at least two fields of interlaced scan lines, with each scan line including a series of pixels having respective intensity values. A motion value representative of the motion between successive frames about the pixel is generated and an edge direction about the pixel is detected. An edge adaptive interpolation at the pixel is performed using the detected edge direction, and a motion adaptive interpolation at the pixel is performed using the generated motion value.

U.S. Pat. No. 6,459,455 to Jiang et al. discloses a method and apparatus for de-interlacing video frames wherein a location for de-interlacing is selected and motion at that location is measured. A de-interlacing method is selected based on the measured motion and a pixel value is created for the location.

U.S. Pat. No. 6,577,345 to Lim et al. discloses a de-interlacing method and apparatus based on motion-compensated interpolation (MCI) and edge-directional interpolation (EDI). De-interlacing of a video signal is conducted using both the MCI and EDI schemes in a single de-interlacing system. An input video signal of an interlaced scan format passes through an MCI block, an EDI block, and a line averaging interpolation (LAI) block, respectively. Respective resultant video signals outputted from the MCI and EDI blocks then pass through MCI and EDI side-effect checking blocks. Based on the checking results outputted by the MCI and EDI side-effect checking blocks, a decision and combination block selects a desired one of the MCI, EDI, LAI pixel indices. The decision and combination block selects an output from the MCI block when MCI is superior. Output from the EDI block is selected when EDI is superior. Where neither MCI nor EDI is satisfactory, an output from the LAI block is selected. When both the MCI and EDI are satisfactory, an average of the MCI and EDI values is derived and outputted as a de-interlaced pixel index.

U.S. Pat. No. 6,614,484 to Lim et al. discloses a de-interlacing method based on edge-directional interpolation to convert video signals of an interlaced scanning format into a progressive scanning format. An intermediate frame is formed from the original interlaced field video. Mismatch values associated with edge directions are compared to determine the four edge directions exhibiting mismatch values less than those of other edge directions. An interpolation pixel value is calculated using the intermediate video frame, indices of the four edge directions, and indices of the edge directions.

U.S. Pat. No. 6,859,235 to Walters discloses adaptive de-interlacing of interlaced video to generate a progressive frame on a per pixel basis. Two consecutive fields of interlaced video are converted into a frame of progressive video. One of the fields is replicated to generate one half of the lines in the progressive frame. Each of the pixels in the other half of the progressive frame is generated on a pixel-by-pixel basis. For a given output position of the pixel in the other half of the progressive frame, a correlation is estimated between the corresponding pixel in the non-replicated field and at least one vertically adjacent pixel of the replicated field, and optionally one or more vertically adjacent pixels in the non-replicated fields.

U.S. Patent Application Publication No. 2003/0218691 to Gray discloses de-interlacing of a composite video image that includes alternating even and odd rows of pixels. The even rows are used to form a first image and the odd rows are used to form a second image. As these images are recorded at different times, there is a possibility of motion artifact. A first average horizontal intensity difference is computed between the first image and the second image. The first image is offset by one pixel in each horizontal direction to form a horizontally offset image, and another average horizontal intensity difference is computed. A minimum average intensity difference is determined from a comparison of the average horizontal intensity differences. The first image is then shifted in a horizontal direction determined to achieve the minimum average horizontal intensity difference, and the horizontally shifted first image is combined with the second image to form an improved composite image. An analogous series of steps is carried out in the vertical direction.

U.S. Patent Application Publication No. 2004/0119884 to Jiang discloses an edge adaptive spatial temporal de-interlacing filter that evaluates multiple edge angles and groups them into left-edge and right-edge groups for reconstructing desired pixel values. A leading edge is selected from each group, forming the final three edges (left, right and vertical) to be determined. Spatial temporal filtering is applied along the edge directions.

U.S. Patent Application Publication No. 2004/0120605 to Lin et al. discloses an edge-oriented interpolation method for de-interlacing with sub-pixel accuracy. To interpolate a missing pixel of a first scan line, a first pixel group of a second scan line and a second pixel group of a third scan line in a first orientation are provided, and a third pixel group of the second scan line and a fourth pixel group of the third scan line in a second orientation are provided. Then, a first sub-pixel of the second scan line is calculated according to the first pixel group and the third pixel group, and a second sub-pixel of the third scan line is calculated according to the second pixel group and the fourth pixel group by employing a linear interpolation method or an ideal interpolation function based on the sampling theorem. Thereafter, the missing pixel is interpolated according to the first sub-pixel and the second sub-pixel.

U.S. Patent Application Publication No. 2004/0135925 to Song et al. discloses a de-interlacing apparatus capable of outputting two consecutive de-interlaced frames that includes a field buffer, a shift buffer, a frame generator and a line exchanger. The field buffer receives and stores a plurality of consecutive interlaced fields and then outputs, in response to a control signal, p-th interlaced line data of an m-th field, p-th interlaced line data of an (m+2)-th field, p-th interlaced line data of an (m+1)-th field and (p+1)-th interlaced line data of the (m+1)-th field in series or the p-th interlaced line data of the (m+1)-th field, p-th interlaced line data of an (m+3)-th field, the p-th interlaced line data of the (m+2)-th field, and (p+1)-th interlaced line data of the (m+2)-th field in series. The shift buffer, which receives the line data output from the field buffer in series, converts the line data into parallel signals and outputs first through fourth line data in parallel. The frame generator, which receives the first through fourth line data from the shift buffer, senses motion in the first through fourth line data between fields and selectively outputs temporally filtered adjacent line data or spatially filtered adjacent line data in response to the motion sensing result. The line exchanger receives the first line data of the shift buffer and an output signal of the frame generator and selectively exchanges the first line data with line data output by the frame generator in response to a line exchange signal.

U.S. Patent Application Publication No. 2004/0207753 to Jung discloses an apparatus and method for de-interlacing an interlaced image signal. A weight value is calculated after detecting the degree of motion of a pixel of a previous field and a pixel of a subsequent field relative to a pixel of a current field to be interpolated. An inter-field interpolation value is calculated based on pixels in previous and subsequent fields corresponding to the pixel to be interpolated. An intra-field interpolation value is calculated based on adjacent pixels in the same field as the pixel to be interpolated. A final interpolation value is calculated based on the inter-field interpolation value, the intra-field interpolation value and the weight value.

U.S. Patent Application Publication No. 2004/0233326 to Yoo et al. discloses an image signal de-interlacing apparatus for converting an interlaced scanning image into a progressive scanning image. The de-interlacing apparatus includes an intra-field pixel processing unit for detecting a face area and to-be-interpolated data within a field by using pixels of a field disposed before two fields from a current field. A motion value generating unit detects first to third motion values and first and second motion degree values. A history control unit detects a history value and a fast image processing unit detects a fast motion image. A film image processing unit detects a film image and a caption area and determines to-be-interpolated field data. A still image processing unit accumulates the first motion value and the second motion degree value to detect a still image. An inter-field noise image processing unit detects an adjacent inter-field noise image and a motion boundary maintenance image processing unit detects a motion boundary maintenance image. A synthesizing unit selectively interpolates the intra-field to-be-interpolated data, the before-one-field inter-field data and the before-three-field inter-field data according to the detection result.

U.S. Patent Application Publication No. 2005/0036061 to Fazzini discloses a method and apparatus for deriving a progressive scan image from an interlaced image. For each pixel to be inserted in the field from the interlaced image, a difference value is derived from each pair of a set of symmetrically opposed pixels with respect to the pixel to be reconstructed and from adjacent lines to the pixel to be reconstructed. A determination is made as to which pair of pixels has the lowest difference value associated with it and the average value of this pixel pair is selected as the value of the pixel to be inserted.

U.S. Patent Application Publication No. 2005/0046741 to Wu discloses a method of transforming output formats of video data without degrading display quality. The video data includes a plurality of first display data corresponding to a plurality of first odd fields and a plurality of second display data corresponding to a plurality of first even fields. The first display data and the second display data are interlaced to form a plurality of first frames corresponding to a first resolution. The first and second display data are de-interlaced to generate a plurality of third display data and the third display data is adjusted to correspond to a second resolution. A plurality of fourth display data corresponding to a plurality of second odd fields and a plurality of fifth display data corresponding to a plurality of second even fields is extracted from the third display data.

U.S. Patent Application Publication No. 2005/0073607 to Ji et al. discloses a de-interlacing device and method for converting a video signal of an interlaced scan format into a video signal of a progressive scan format. The de-interlacing method includes measuring an edge gradient from a series of pixels provided in an upper scan line and a series of pixels provided in a lower scan line with reference to a pixel to be interpolated. An interpolation method is determined on the basis of the measured edge gradient. A difference value is calculated for each pixel pair combination. An edge direction is determined on the basis of the direction of the pixel pair combination having the smallest difference value and an interpolation for the pixel is performed depending on the determined interpolation method and the determined edge direction.

U.S. Patent Application Publication No. 2005/0099538 to Wredenhagen al. discloses an adaptive filter that calculates a target pixel from an interlaced video signal. The video signal comprises a plurality of frames, each of which comprises an even field and an odd field. The filter comprises a quantized motion calculator and a filter selector. The quantized motion calculator estimates the amount of motion about the target pixel. The filter selector selects a filter in accordance with the estimated amount of motion. The filter applies a first weighting factor to a plurality of current field pixels and a second weighting factor to a plurality of previous field pixels thereby to create the target pixel.

U.S. Patent Application Publication No. 2005/0110902 to Yang discloses a de-interlacing apparatus with a noise reduction/removal device. The noise reduction/removal device includes a motion prediction unit that predicts motion vectors between an image one period ahead of a previous image and a current image with respect to individual images which are sequentially inputted. A motion checking unit applies the motion vectors predicted by the motion prediction unit to the image one period ahead of the previous image and two different images ahead of the current image in time, and checks whether the motion vectors are precise motion vectors. A motion compensation unit compensates for motion and a noise removal unit removes noise on images using the motion-compensated images and the inputted images.

U.S. Patent Application Publication No. 2005/0122426 to Winger et al. discloses a method and apparatus for de-interlacing a picture. During the method, a plurality of differences among a plurality of current samples from a current field of the picture is calculated. The differences are calculated along a plurality of line segments at a plurality of angles proximate a particular position between two field lines from the current field. A first sample at the particular position is generated by vertical filtering the current field in response to the differences indicating that the particular position is a non-edge position in the picture. A second sample at the particular position is generated by directional filtering the current field in response to the differences indicating that the particular position is an edge position in the picture.

U.S. Patent Application Publication No. 2005/0129306 to Wang et al. discloses a method for interpolating an omitted scan line between two neighboring scan lines of an interlaced image. During the method, an edge direction of the image at a selected point on the omitted scan line is detected and a neural network is selected based upon the detected edge direction. The neural network provides an interpolated value for the selected point.

U.S. Patent Application Publication No. 2005/0134730 to Winger et al. discloses a method for de-interlacing a picture. During the method, a protection condition is determined by performing a static check on the picture in a region around a location interlaced with a first field of the picture. An interpolated sample at the location is calculated by temporal averaging the first field with a second field in response to the protection condition indicating significant vertical activity. The interpolated sample at the location is calculated by spatial filtering the first field in response to the protection condition indicating insignificant vertical activity.

Although many techniques for generating progressive video signals from interlaced video signals exist, improvements are desired. It is therefore an object of the present invention at least to provide a novel system and method of deinterlacing interlaced video signals to produce progressive video signals.

### SUMMARY OF THE INVENTION

According to one aspect, there is provided a method of deinterlacing interlaced even scanline and odd scanline video frames to form a progressive video frame. The method comprises populating even scanlines of an even full-field frame with the scanlines of the interlaced even scanline video frame and populating odd scanlines of an odd full-field frame with the scanlines of the interlaced odd scanline video frame. Each of the even and odd full-field frames is then subjected to a doubling procedure to populate odd scanlines of the even full-field frame and to populate even scanlines of the odd full-field frame thereby to complete the even and odd full-field frames. The complete even and odd full-field frames are processed to determine motion. Pixels of the interlaced even scanline and odd scanline video frames and one of the complete even and odd full-field frames are then selected using the determined motion thereby to generate the progressive video frame.

During the processing, a map representing motion is generated with the map being used to select the pixels. In one embodiment, the map identifies stationary and moving edges in the complete even and odd full-field frames. In this case, during the processing, each of the complete even and odd full-field frames is subjected to edge detection to yield even and odd full-field edge frames. The even and odd full-field edge frames are compared to determined stationary and moving edges. The map is generated based on the results of the comparing. During the map generating, pixel locations of the map corresponding to stationary edges are assigned a first pixel value and pixels of the map corresponding to moving edges are assigned a second pixel value.

In an alternative embodiment, during the map generating, the absolute difference between the complete even and odd full-field frames is determined thereby to generate a current full-field difference frame. The absolute difference between the current full-field difference frame and a previously generated full-field difference frame is then determined to generate a resultant full-field difference frame. The map is generated based on the resultant full-field difference frame. During the map generating, the value of each pixel of the resultant full-field difference frame is compared to a threshold. Pixels having a value less than or equal to the threshold are assigned a first pixel value and pixels having a value exceeding the threshold are assigned a second pixel value.

In one embodiment, the doubling procedure subjecting comprises interpolating pixels of the even scanlines of the even full-field frame to generate pixels of the odd scanlines of the even full-field frame and interpolating pixels of the odd scanlines of the odd full-field frame to generate pixels of the even scanlines of the odd full-field frame. The interpolating for each pixel being generated comprises determining difference values between a plurality of pairs of pixels surrounding each pixel to be generated and determining the pixel pair that yields the smallest difference value. A mean intensity value for the determined pixel pair is calculated and the calculated mean intensity value is used as the value of the pixel being generated.

According to another aspect, there is provided a system for deinterlacing interlaced even scanline and odd scanline video frames to form a progressive video frame. The system comprises an input interface receiving the interlaced even scanline and odd scanline video frames, an output interface outputting the progressive video frame and processing structure. The processing structure, in response to received interlaced even scanline and odd scanline video frames, populates even scanlines of an even full-field frame with the scanlines of the interlaced even scanline video frame and populates odd scanlines of an odd full-field frame with the scanlines of the interlaced odd scanline video frame; subjects each of the even and odd full-field frames to a doubling procedure to populate odd scanlines of the even full-field frame and to populate even scanlines of the odd full-field frame thereby to complete the even and odd full-field frames; processes the complete even and odd full-field frames to determine motion; and selects pixels of the interlaced even scanline and odd scanline video frames and one of the complete even and odd full-field frames using the determined motion thereby to generate the progressive video frame.

According to yet another aspect, there is provided a computer-readable medium embodying machine-readable code for deinterlacing interlaced even scanline and odd scanline video frames to form a progressive video frame. The machine-readable code comprises machine-readable code for populating even scanlines of an even full-field frame with the scanlines of the interlaced even scanline video frame and populating odd scanlines of an odd full-field frame with the scanlines of the interlaced odd scanline video frame; machine-readable code for subjecting each of the even and odd full-field frames to a doubling procedure to populate odd scanlines of the even full-field frame and to populate even scanlines of the odd full-field frame thereby to complete the even and odd full-field frames; machine-readable code for processing the complete even and odd full-field frames to determine motion; and machine-readable code for selecting pixels of the interlaced even scanline and odd scanline video frames and one of the complete even and odd full-field frames using the determined motion thereby to generate the progressive video frame.

### BRIEF DESCRIPTION OF THE DRAWINGS

Embodiments will now be described more fully with reference to the accompanying drawings in which:

FIGS. 1a and 1b show consecutive interlaced video frames;

FIG. 1c shows a progressive video frame formed by merging the interlaced video frames of FIGS. 1a and 1b;

FIGS. 1d and 1e show consecutive interlaced video frames;

FIG. 1f shows a progressive video frame formed by merging the interlaced video frames of FIGS. 1d and 1e;

FIG. 2 is a schematic block diagram of a system for deinterlacing interlaced video frames to form progressive video frames;

FIG. 3 is a flowchart showing the general deinterlacing method employed by the system of FIG. 2;

FIG. 4 is a flowchart showing the steps performed during even and odd full-field frame doubling;

FIG. 5 shows neighboring pixels surrounding a target pixel to be interpolated;

FIG. 6 is a flowchart showing the steps performed during motion map generation;

FIG. 7 is a flowchart showing the steps performed during progressive video frame population; and

FIG. 8 is a flowchart showing alternate steps performed during motion map generation.

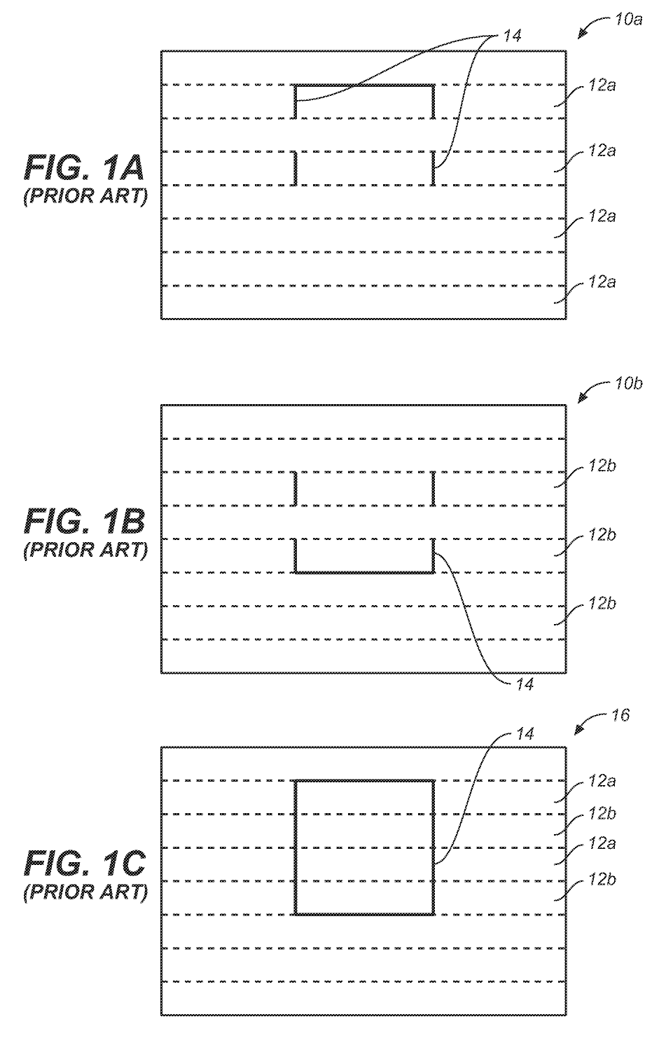

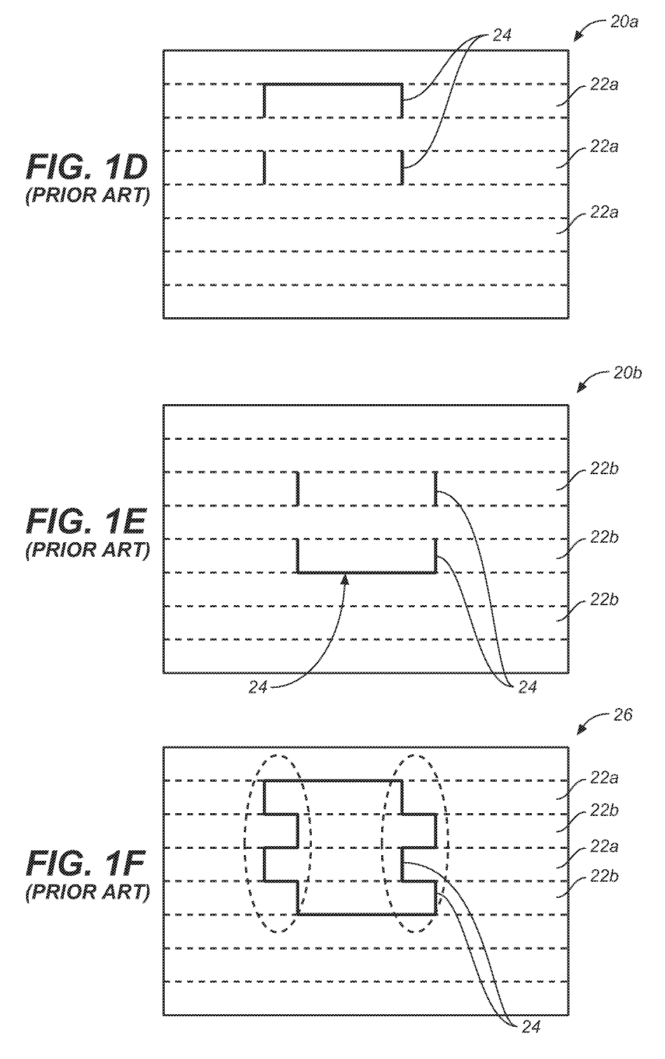

### DETAILED DESCRIPTION OF THE EMBODIMENTS

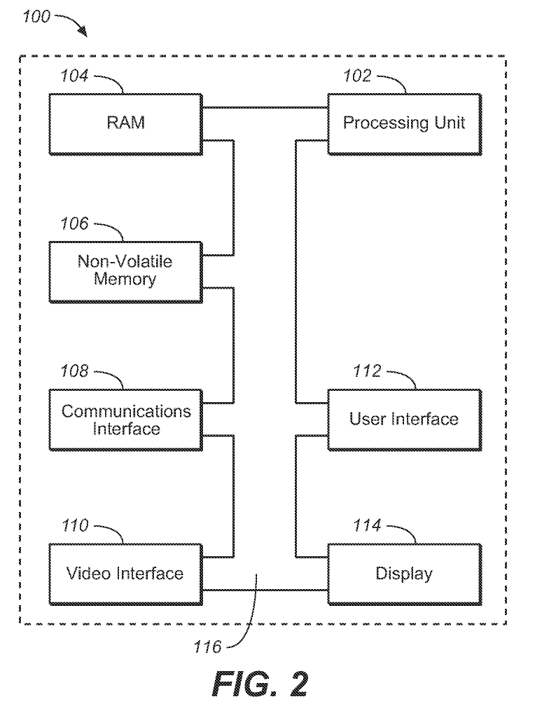

Turning now to FIG. 2, a system for deinterlacing interlaced video frames is shown and is generally identified by reference numeral 100. As can be seen, the system 100 comprises a processing unit 102, random access memory (“RAM”) 104, non-volatile memory 106, a communications interface 108, a video interface 110, a user interface 112 and a display 114, all in communication over a local bus 116. The processing unit 102 retrieves a deinterlacing software application from the non-volatile memory 106 into the RAM 104 for execution. Upon execution of the deinterlacing software application, pairs of input interlaced video frames that are received via communication interface 108 and/or video interface 110 are deinterlaced in order to form progressive video frames. Once deinterlaced, the progressive video frames may be viewed on display 114. Via user interface 112, a user may also elect to transfer the generated progressive video frames to a local memory device such as non-volatile memory 106, a remote storage device or facility (not shown) by means of communications interface 108, or to another local or remote display device (e.g., LCD display).

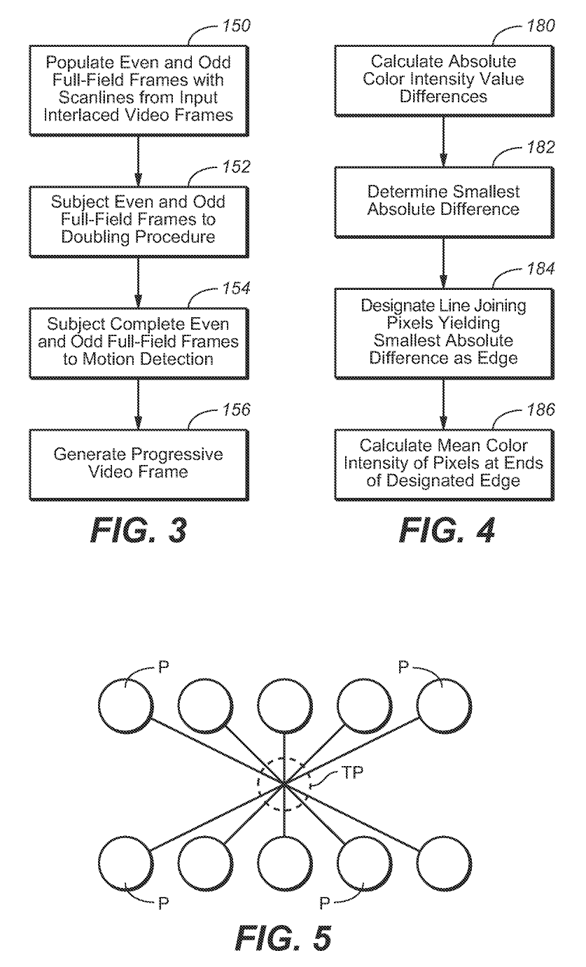

FIG. 3 shows the general steps performed by the system 100 during deinterlacing of input interlaced video frames. Initially for each pair of input interlaced video frames, the input interlaced even scanline video frame is used to populate the even scanlines of an even full-field or full-screen display frame and the input interlaced odd scanline video frame is used to populate the odd scanlines of an odd full-field frame (step 150). As a result, the even full-field frame is missing pixel data along its odd scanlines and the odd full-field frame is missing pixel data along its even scanlines. Each of the even full-field and odd full-field frames is then subjected to a doubling procedure to interpolate the missing pixel data therein resulting in complete even full-field and odd full-field frames (step 152). Each of the complete even full-field and odd full-field frames is then subjected to a motion detection procedure and a motion map is generated (step 154). Pixels either from the input interlaced even and odd scanline video frames or the complete even full-field frame are then selected based on the motion map thereby to form the progressive video frame (step 156). Further specifics concerning the above method will now be described with reference to FIGS. 4 to 7.

During the doubling procedure at step 152, the missing pixel data along the odd scanlines of the even full-field frame and along the even scanlines of the odd full-field frame is interpolated to yield the complete even and odd full-field frames. As the doubling procedure is the same for each of the even and odd full-field frames, for ease of discussion, the doubling procedure will be described for the even full-field frame with reference to FIGS. 4 and 5.

Initially, for each missing target pixel TP along the odd scanlines of the even full-field frame that is to be interpolated, the absolute difference between the color intensity values of a plurality of pairs of neighbouring pixels on opposite sides of the target pixel are calculated (step 180). In this embodiment, where possible, absolute differences between color intensity values of five (5) pairs of pixels are calculated. As can be seen in FIG. 5, one of the pairs of neighboring pixels P is along a vertical line intersecting the target pixel TP, two of the pairs of neighboring pixels P are along right diagonal lines intersecting the target pixel TP and two of the pairs of neighboring pixels P are along left diagonal lines intersecting the target pixel TP. As will be appreciated, for target pixels adjacent the edges of the even full-field frame where fewer neighboring pixels exist, fewer absolute differences are calculated. Once the absolute differences have been determined, the absolute differences are examined to determine the smallest absolute difference (step 182). The line joining the two neighboring pixels P yielding the smallest absolute difference is then designated as an edge (step 184). The mean color intensity value of the two neighboring pixels P at the ends of the designated edge is then calculated and is used as the value of the target pixel TP (step 186). As mentioned above, steps 180 to 186 are performed for each missing target pixel along the odd scanlines of the even full-field frame and along the even scanlines of the odd full-field frame resulting in complete even and odd full-field frames.

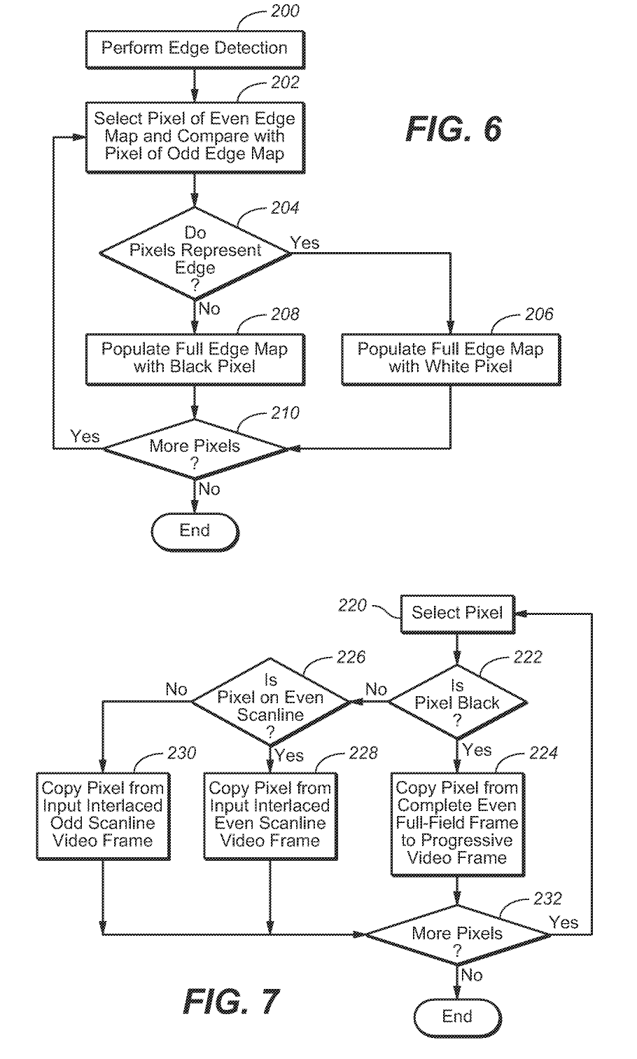

At step 154 during motion detection, edge detection is performed on each of the complete even and odd full-field frames thereby to yield even and odd edge maps (step 200 in FIG. 6). In this embodiment, Sobel edge detection is performed although alternative edge detection methods can be employed. With the two edge maps generated, a first pixel of the even edge map is selected and compared with its corresponding pixel of the odd edge map (step 202) to determine if the pixels being compared both represent an edge (step 204). If both pixels represent an edge, a pixel having a white color intensity value is placed at a corresponding pixel location in a full edge map (step 206). Otherwise, a pixel having a black color intensity value is placed at the corresponding pixel location in the full edge map (step 208). A check is then made to determine whether one or more other pixels of the even edge map exist that have not been selected and compared with their corresponding pixels of the odd edge map (step 210). If one or more such other pixels exist, the process reverts back to step 202 and the next pixel is selected. When no other such pixel exists, the full edge map is fully populated and the process is complete.

Once the full edge map has been generated, a first pixel of the full edge map is selected (step 220 in FIG. 7) and a check is made to determine whether selected pixel has a black color intensity value (step 222). If the selected pixel has a black color intensity value, a moving edge is signified. In this case, the pixel in the complete even full-field frame corresponding to the selected pixel of the full edge map is copied and used to populate the progressive video frame (step 224). If the selected pixel has a white color intensity value, a stationary edge is signified. In this case, the selected pixel is examined to determine if the pixel is located on an even scanline (step 226). If the selected pixel is located on an even scanline, the pixel in the input interlaced even scanline video frame corresponding to the selected pixel of the full edge map is copied and used to populate the progressive video frame (step 228). If the selected pixel is located on an odd scanline, the pixel in the input interlaced odd scanline video frame corresponding to the selected pixel of the full edge map is copied and used to populate the progressive video frame (step 230). A check is then made to determine whether one or more other pixels of the full edge map exist that have not been selected (step 232). If one or more such other pixels exist, the process reverts back to step 220 and the next pixel is selected. When no such other pixels exist, the progressive video frame is fully populated and the process is complete.

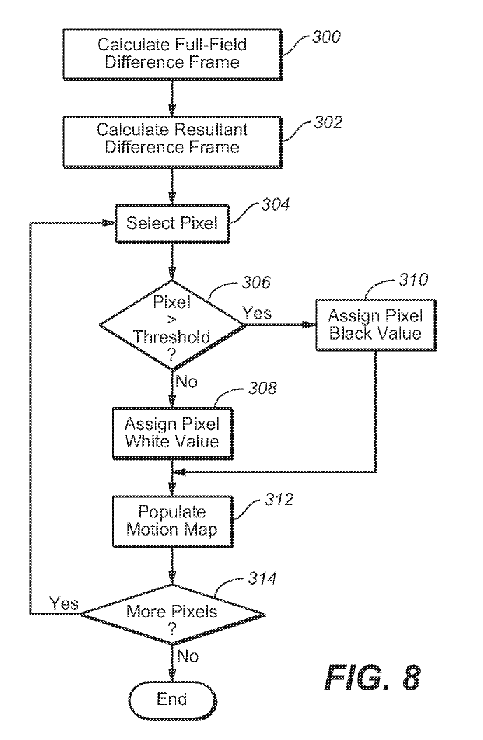

Turning now to FIG. 8, an alternative method of processing the even and odd full-field frames to determine motion is shown. During this method, rather than subjecting the even and odd full-field frames to edge detection, the absolute difference between color intensity values of corresponding pixels of the complete even and odd full-field frames is firstly calculated thereby to form a full-field difference frame (step 500). The absolute difference between the pixel values of the full-field difference frame and the full-field difference frame generated for the previously processed pair of input interlaced video frames is then calculated to yield a resultant difference frame (step 302). A first pixel of the resultant difference frame is then selected (step 304) and compared with a threshold value (step 306). If the selected pixel has a value less than or equal to the threshold value, the pixel is assigned a white color intensity value (step 308). If the pixel has a value greater then the threshold value, the pixel is assigned a black intensity color value (step 310). The assigned color intensity value is then used to populate the corresponding pixel location of a motion map (step 312). A check is then made to determine whether one or more other pixels of the resultant difference frame exist that have not been selected (step 314). If one or more such other pixels exist, the process reverts back to step 304 and the next pixel is selected. When no other such pixel exists, the motion map is fully populated and the process is complete.

Once the motion map has been generated, the process reverts to step 220 where a first pixel of the motion map is selected (step 220) and a check is made to determine whether selected pixel has a black color intensity value (step 222). If the selected pixel has a black color intensity value, motion is signified. In this case, the pixel in the complete even full-field frame corresponding to the selected pixel of the motion map is copied and used to populate the progressive video frame (step 224). If the selected pixel has a white color intensity value, the selected pixel is examined to determine if the pixel is located on an even scanline (step 226). If the selected pixel is located on an even scanline, the pixel in the input interlaced even scanline video frame corresponding to the selected pixel of the motion map is copied and used to populate the progressive video frame (step 228). If the selected pixel is located on an odd scanline, the pixel in the input interlaced odd scanline video frame corresponding to the selected pixel of the motion map is copied and used to populate the progressive video frame (step 230). A check is then made to determine whether any one or more pixels of the motion map exist that have not been selected (step 232). If one or more such other pixels exist, the process reverts back to step 220 and the next pixel is selected. When no such other pixels exist, the progressive video frame is fully populated and the process is complete.

As will be appreciated, in this embodiment the value of the threshold determines how loosely or tightly motion is defined. Increasing or decreasing the threshold value has an impact on the resolution of the resultant progressive video frame and the presence of artifacts.

If desired, additional filters that determine whether pixels from the input interlaced even and odd scanline video frames or pixels from the even full-field frame are to be used during formation of the progressive video frame can be employed. For example, after the progressive video frame has been generated, each pixel copied from the complete even full-field frame (i.e. those pixels representing motion) can be compared with the corresponding pixel in the appropriate input interlaced video frame, the pixels in the progressive video frame above and below it and the corresponding pixel in the previously generated progressive video frame to determine if any of the comparisons exceed user specified thresholds. If not, the value of the pixel is maintained. If so, the value of the pixel is replaced with that of the corresponding pixel in the appropriate input interlaced video frame. Of course, a subset of the above comparisons may be employed to determine whether pixels are to be maintained or replaced.

Also if desired, rather than selecting pixels from the complete even full-field frame when moving edges are detected, those of skill in the art will appreciate that pixels from the complete odd full-field frame can be selected when moving edges are detected.

The deinterlacing software application may include program modules including routines, programs, object components, data structures etc. and be embodied as computer readable program code stored on a computer readable medium. The computer readable medium is any data storage device that can store data, which can thereafter be read by a computer system. Examples of computer readable medium include for example read-only memory, random-access memory, CD-ROMs, magnetic tape and optical data storage devices. The computer readable program code can also be distributed over a network including coupled computer systems so that the computer readable program code is stored and executed in a distributed fashion.

Although embodiments have been described, those of skill in the art will appreciate that variations and modifications may be made without departing from the spirit and scope thereof as defined by the appended claims.

1. A method of deinterlacing interlaced even scanline and odd scanline video frames to form a progressive video frame, said method comprising:
populating even scanlines of an even full-field frame with the scanlines of said interlaced even scanline video frame and populating odd scanlines of an odd full-field frame with the scanlines of said interlaced odd scanline video frame;
subjecting each of said even and odd full-field frames to a doubling procedure to populate odd scanlines of said even full-field frame and to populate even scanlines of said odd full-field frame thereby to complete said even and odd full-field frames;
processing the complete even and odd full-field frames to determine motion; and
selecting pixels of said interlaced even scanline and odd scanline video frames and one of said complete even and odd full-field frames using the determined motion thereby to generate the progressive video frame.

2. The method of claim 1 wherein during said processing a map representing motion is generated, said map being used to select said pixels.

3. The method of claim 2 wherein said map identifies stationary and moving edges in said complete even and odd full-field frames.

4. The method of claim 3 wherein said processing comprises:
subjecting each of said complete even and odd full-field frames to edge detection to yield even and odd full-field edge frames;
comparing said even and odd full-field edge frames to determine stationary and moving edges; and
generating said map based on the results of said comparing.

5. The method of claim 4 wherein during said map generating, pixel locations of said map corresponding to stationary edges are assigned a first pixel value and pixel locations of said map corresponding to moving edges are assigned a second pixel value.

6. The method of claim 5 wherein said first pixel value and second pixel value are generally opposite color intensity values.

7. The method of claim 6 wherein said first pixel value represents a white pixel and said second pixel value represents a black pixel.

8. The method of claim 5 wherein during said edge detection subjecting, said complete even and odd full-field frames are subjected to Sobel edge detection.

9. The method of claim 1 wherein said doubling procedure subjecting comprises:
interpolating pixels of the even scanlines of said even full-field frame to generate pixels of the odd scanlines of said even full-field frame; and
interpolating pixels of the odd scanlines of said odd full-field frame to generate pixels of the even scanlines of said odd full-field frame.

10. The method of claim 9 wherein said interpolating comprises for each pixel being generated:
determining difference values between a plurality of pairs of pixels surrounding each pixel to be generated;
determining the pixel pair that yields the smallest difference value;
calculating a mean intensity value for the determined pixel pair; and using the calculated mean intensity value as the value of the pixel being generated.

11. The method of claim 10 wherein said difference values are color intensity difference values.

12. The method of claim 11 wherein color intensity difference values between five pixel pairs are determined.

13. The method of claim 4 wherein said doubling procedure subjecting comprises:
interpolating pixels of the even scanlines of said even full-field frame to generate pixels of the odd scanlines of said even full-field frame; and
interpolating pixels of the odd scanlines of said odd full-field frame to generate pixels of the even scanlines of said odd full-field frame.

14. The method of claim 13 wherein said interpolating comprises for each pixel being generated:
determining difference values between a plurality of pairs of pixels surrounding each pixel to be generated;
determining the pixel pair that yields the smallest difference value;
calculating a mean intensity value for the determined pixel pair; and
using the calculated mean intensity value as the value of the pixel being generated.

15. The method of claim 14 wherein said difference values are color intensity difference values.

16. The method of claim 15 wherein color intensity difference values between five pixel pairs are determined.

17. The method of claim 2 wherein said map generating comprises:
determining the absolute difference between the complete even and odd full-field frames thereby to generate a current full-field difference frame;
determining the absolute difference between the current full-field difference frame and a previously generated full-field difference frame thereby to generate a resultant full-field difference frame; and
generating said map based on the resultant full-field difference frame.

18. The method of claim 17 wherein during said map generating, the value of each pixel of said resultant full-field difference frame is compared to a threshold, pixels having a value less than or equal to said threshold being assigned a first pixel value and pixels having a value exceeding said threshold being assigned a second pixel value.

19. The method of claim 18 wherein said first pixel value and second pixel value are generally opposite color intensity values.

20. The method of claim 19 wherein said first pixel value represents a white pixel and said second pixel value represents a black pixel.

21. The method of claim 18 wherein said doubling procedure subjecting comprises:
interpolating pixels of the even scanlines of said even full-field frame to generate pixels of the odd scanlines of said even full-field frame; and
interpolating pixels of the odd scanlines of said odd full-field frame to generate pixels of the even scanlines of said odd full-field frame.

22. The method of claim 21 wherein said interpolating comprises for each pixel being generated:
determining difference values between a plurality of pairs of pixels surrounding each pixel to be generated;
determining the pixel pair that yields the smallest difference value;
calculating a mean intensity value for the determined pixel pair; and
using the calculated mean intensity value as the value of the pixel being generated.

23. The method of claim 22 wherein said difference values are color intensity difference values.

24. The method of claim 23 wherein color intensity difference values between five pixel pairs are determined.

25. A system for deinterlacing interlaced even scanline and odd scanline video frames to form a progressive video frame comprising:
an input interface receiving the interlaced even scanline and odd scanline video frames;
processing structure, in response to received interlaced even scanline and odd scanline video frames, populating even scanlines of an even full-field frame with the scanlines of said interlaced even scanline video frame and populating odd scanlines of an odd full-field frame with the scanlines of said interlaced odd scanline video frame; subjecting each of said even and odd full-field frames to a doubling procedure to populate odd scanlines of said even full-field frame and to populate even scanlines of said odd full-field frame thereby to complete said even and odd full-field frames; processing the complete even and odd full-field frames to determine motion; and selecting pixels of said interlaced even scanline and odd scanline video frames and one of said complete even and odd full-field frames using the determined motion thereby to generate the progressive video frame; and
an output interface outputting said progressive video frame.

26. A computer-readable medium embodying machine-readable code for deinterlacing interlaced even scanline and odd scanline video frames to form a progressive video frame, said machine-readable code comprising:
machine-readable code for populating even scanlines of an even full-field frame with the scanlines of said interlaced even scanline video frame and populating odd scanlines of an odd full-field frame with the scanlines of said interlaced odd scanline video frame;
machine-readable code for subjecting each of said even and odd full-field frames to a doubling procedure to populate odd scanlines of said even full-field frame and to populate even scanlines of said odd full-field frame thereby to complete said even and odd full-field frames;
machine-readable code for processing the complete even and odd full-field frames to determine motion; and
machine-readable code for selecting pixels of said interlaced even scanline and odd scanline video frames and one of said complete even and odd full-field frames using the determined motion thereby to generate the progressive video frame.
